(19) United States
(12) Patent Application Publication
(10) Pub. No.: US 2006/0283983 A1
(43) Pub. Date: Dec. 21, 2006

(54) Common rail injector

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/555,689

(22) PCT Filed: Feb. 18, 2005
(86) PCT No.: PCT/EP05/50714

§ 371 Date: Nov. 4, 2005

(30) Foreign Application Priority Data
Apr. 20, 2004 (DE) 1020040189277

(51) Int. Cl. F02M 47/02; F02M 61/00; F02M 63/00

(52) U.S. Cl. 239/533.2; 239/88; 239/533.12

(57) ABSTRACT

A common rail injector having an injector housing having a fuel inlet in communication with a central high-pressure fuel source outside the injector housing and a pressure chamber inside the injector housing, from which, as a function of the pressure in a control chamber, fuel subjected to high pressure is injected into a combustion chamber of an internal combustion engine when a nozzle needle lifts from its seat, the pressure in the control chamber being controlled directly by means of an actuator, in particular a piezoelectric actuator. The installation space required is reduced by a further control chamber connected in series with the first control chamber.

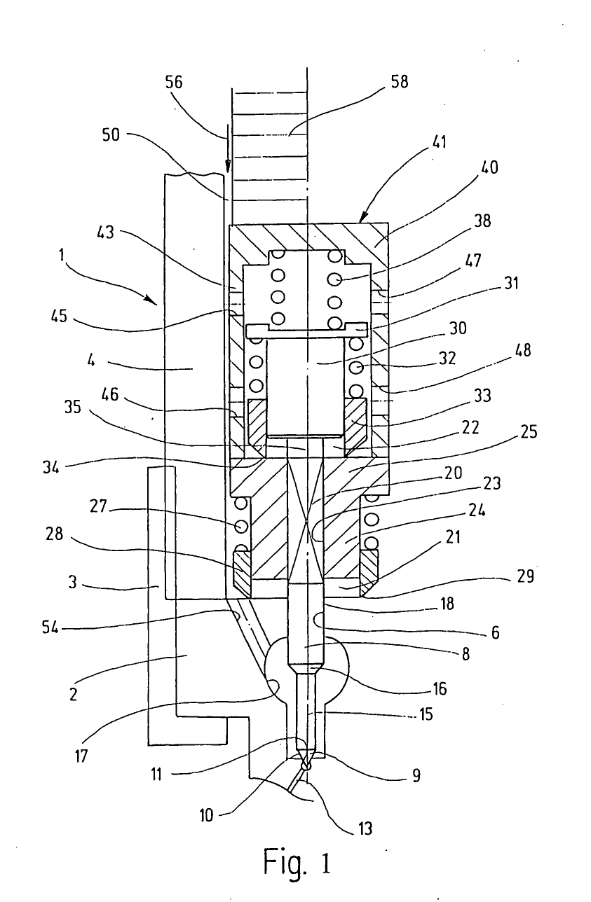

The invention relates to a common rail injector having an injector housing, which has a fuel inlet that is in communication with a central high-pressure fuel source outside the injector housing and with a pressure chamber inside the injector housing, from which, as a function of the pressure in a control chamber, fuel subjected to high pressure is injected into a combustion chamber of an internal combustion engine when a nozzle needle lifts from its seat, the pressure in the control chamber being controlled directly by means of an actuator, in particular a piezoelectric actuator.

### PRIOR ART

When the pressure in the control chamber is controlled by an actuator, in particular a piezoelectric actuator, this is called direct nozzle needle control. Conventional common rail injectors with direct and non-inverse triggering of the nozzle needle are complicated in structure and require a relatively large amount of installation space, particularly in terms of diameter. Non-inverse triggering means triggering of an injector in which the nozzle needle lifts from its seat when the actuator, in particular the piezoelectric actuator, is supplied with current.

The object of the invention is to create a common rail injector having an injector housing, which has a fuel inlet that is in communication with a central high-pressure fuel source outside the injector housing and with a pressure chamber inside the injector housing, from which, as a function of the pressure in a control chamber, fuel subjected to high pressure is injected into a combustion chamber of an internal combustion engine when a nozzle needle lifts from its seat, the pressure in the control chamber being controlled directly by means of an actuator, in particular a piezoelectric actuator, which particularly in diameter requires less installation space than conventional injectors.

### SUMMARY OF THE INVENTION

This object is attained, a common rail injector having an injector housing, which has a fuel inlet that is in communication with a central high-pressure fuel source outside the injector housing and with a pressure chamber inside the injector housing, from which, as a function of the pressure in a control chamber, fuel subjected to high pressure is injected into a combustion chamber of an internal combustion engine when a nozzle needle lifts from its seat, the pressure in the control chamber being controlled directly by means of an actuator, in particular a piezoelectric actuator, by providing that a further control chamber is connected in series with the first control chamber. In conjunction with the present invention, direct control of the pressure in the control chamber is understood to mean the generation of a pressure drop and/or a pressure increase in the control chamber as a consequence of the volumetric change in the actuator. By connecting a plurality of control chambers in series with one another, the force reversal required in non-inverse triggering can be realized in a more slender way than in conventional injectors.

A preferred exemplary embodiment of the injector is characterized in that a coupling sleeve is located between the actuator and a first booster piston, whose end face, toward the combustion chamber, defines the first control chamber, and whose end face remote from the combustion chamber defines the second control chamber, each in the axial direction. Since both the actuator, or an actuator head provided on the actuator, and the first booster piston are in contact with the coupling sleeve, a volumetric expansion occurring when current is supplied to the actuator is transmitted via the coupling sleeve to the first booster piston. A volumetric expansion of the actuator for thus a pressure increase in the first control chamber.

A preferred exemplary embodiment of the injector is characterized in that the first booster piston has a central through hole, through which the nozzle needle extends. Accordingly, both the first and the second control chamber are defined radially inward by the nozzle needle.

A preferred exemplary embodiment of the injector is characterized in that the nozzle needle, in the region of the first booster piston, has at least one flat face, which creates a communication between the first control chamber and the second control chamber. As a result of this fluidic communication, a pressure equalization between the two control chambers is assured along the nozzle needle.

A preferred exemplary embodiment of the injector is characterized in that the first control chamber is defined radially outward by a first spring-prestressed control chamber limiting sleeve, which is guided in a sealing manner on the first booster piston. The space outside the first control chamber is preferably subjected to high pressure; that is, it is in communication with the high-pressure fuel source outside the injector housing.

A preferred exemplary embodiment of the injector is characterized in that the second control chamber is located in the axial direction between the first booster piston and a second booster piston, whose end face remote from the combustion chamber is subjected to high pressure. Thus a pressure increase in the second control chamber acts on the second booster piston.

A preferred exemplary embodiment of the injector is characterized in that the second booster piston is located inside the coupling sleeve in such a manner that it is movable back and forth in the axial direction between the nozzle needle and a nozzle spring that is braced on the end of the coupling sleeve remote from the combustion chamber. The nozzle needle is located with its end remote from the combustion chamber in contact with the end face, toward the combustion chamber, of the second booster piston. When the pressure in the second control chamber increases because of a volumetric expansion of the actuator, the second booster piston then moves away from the combustion chamber, counter to the prestressing force of the nozzle spring, so that because of the pressure in the pressure chamber and the resultant pressure forces, the nozzle needle lifts from its seat. Fuel is then injected from the pressure chamber into the combustion chamber.

A preferred exemplary embodiment of the injector is characterized in that the second control chamber is defined radially outward by a second spring-prestressed control chamber limiting sleeve, which is guided in a sealing manner on the second booster piston. The space outside the first control chamber is preferably subjected to high pressure; that is, it is in communication with the high-pressure fuel source outside the injector housing.

A preferred exemplary embodiment of the injector is characterized in that the coupling sleeve substantially has the shape of a circular-cylindrical jacket, which is closed on its end remote from the combustion chamber and is opened on its end toward the combustion chamber. The actuator, or an actuator head mounted on the actuator, is in contact on the end of the coupling sleeve remote from the combustion chamber. The first booster piston is in contact on the end of the coupling sleeve toward the combustion chamber. Because the end of the coupling sleeve toward the combustion chamber is open, the end of the nozzle needle remote from the combustion chamber protrudes into the interior of the coupling sleeve where the second booster piston is located.

A preferred exemplary embodiment of the injector is characterized in that in the jacket face of the coupling sleeve, at least one through hole is provided, through which fuel subjected to high pressure reaches the interior of the coupling sleeve. By means of the through hole, it is attained that the interior of the coupling sleeve is in communication with the central high-pressure fuel source outside the injector housing. As a result, the end face, remote from the combustion chamber, of the second booster piston is subjected to high pressure.

Further advantages, characteristics and details of the invention will become apparent from the ensuing description, in which one exemplary embodiment is described in detail, in conjunction with the drawing.

### DESCRIPTION OF THE EXEMPLARY EMBODIMENT

In the accompanying drawing, one exemplary embodiment of a common rail injector according to the invention is shown in longitudinal section. The injector shown has an injector housing, identified overall by reference numeral 1. The injector housing 1 includes a nozzle body 2, which protrudes with its lower free end into the combustion chamber of the internal combustion engine to be supplied. With its upper end face, remote from the combustion chamber, the nozzle body 2 is braced axially by a lock nut 3 against an injector body 4.

An axial guide bore 6 is recessed out of the nozzle body 2. A nozzle needle 8 is guided axially displaceably in the guide bore 6. On the tip 9 of the nozzle needle 8, a sealing face 10 is embodied, which cooperates with a sealing seat or sealing edge 11 that is embodied on the nozzle body 2. When the tip 9 of the nozzle needle 8 is located with its sealing face 10 in contact with the sealing seat 11, an injection port 13 in the nozzle body 2 is closed. It is also possible for a plurality of injection ports to be provided, through which the fuel is injected into the combustion chamber. When the nozzle needle tip 9 lifts from its seat, then fuel subjected to high pressure is injected through the injection port 13 into the combustion chamber of the engine.

Beginning at the tip 9, the nozzle needle 8 has a pressure chamber portion 15, which is adjoined by a frustoconically widening portion 16. The pressure portion 15 and the portion 16, which can also be called a pressure shoulder, are located in a pressure chamber 17 that is embodied in the nozzle body 2.

Adjoining the portion 16, a guide portion 18 is embodied on the nozzle needle 8 and is followed by a portion having a flat face 20. The flat face 20 creates a fluid communication along the nozzle needle 8 between a first control chamber 21, toward the combustion chamber, and a second control chamber 22, remote from the combustion chamber.

The nozzle needle 8 extends through a through hole 23 that is recessed out of a first booster piston 24. The flat face 20 is located in the region of the first booster piston 24; the length of the flat face 20 in the axial direction is somewhat greater than the corresponding length of the first booster piston 24.

On the end remote from the combustion chamber of the first booster piston 24, a collar 25 is embodied on which a prestressing spring 27 is braced. The prestressing spring 27 is fastened between the collar 25 and the end, remote from the combustion chamber, of a first control chamber limiting sleeve 28. A biting edge 29, which is in contact with the nozzle body 2, is embodied on the end, toward the combustion chamber, of the first control chamber limiting sleeve 28.

The first control chamber 21, toward the combustion chamber, is defined in the axial direction by the end face, remote from the combustion chamber, of the nozzle body 2 and by the end face, toward the combustion chamber, of the first booster piston 24. The first control chamber 21 is defined radially inward by the nozzle needle 8. Radially outward, the first control chamber 21 is defined by the first control chamber limiting sleeve 28.

The end 35, remote from the combustion chamber, of the nozzle needle 8 is located in contact with a second booster piston 30, which has a collar 31. A prestressing spring 32 is fastened between the collar 31 and the end face, remote from the combustion chamber, of a second control chamber limiting sleeve 33. A biting edge 34, which contacts the end face, remote from the combustion chamber, of the first booster piston 24 is embodied on the end of the second control chamber limiting sleeve 33 toward the combustion chamber.

The second control chamber 22 is defined in the axial direction by the end face, remote from the combustion chamber, of the first booster piston 24 and by the end face, toward the combustion chamber, of the second booster piston 30. Radially inward, the second control chamber 22 is defined by the nozzle needle 8. Radially outward, the second control chamber 22 is defined by the second control chamber limiting sleeve 31.

A nozzle spring 38 is fastened between the face end, remote from the combustion chamber, of the second booster piston 30 and a bottom 40 of a coupling sleeve 41; by means of this nozzle spring, the nozzle needle 8 is held with its tip 9 in contact with the sealing seat 11. The coupling sleeve 41 essentially has the shape of a circular-cylindrical jacket 43, which is closed, on its end remote from the combustion chamber, by the bottom 40. The end of the coupling sleeve 41 toward the combustion chamber is open and rests radially outward on the end face, remote from the combustion chamber, of the first booster piston 24.

The outer diameter of the coupling sleeve 41 is equivalent to the outer diameter of the first booster piston 24 in the region of the collar 25. The second booster piston 30, the nozzle spring 38, the second control chamber limiting sleeve 33, and the prestressing spring 32 are located in the interior of the coupling sleeve 41.

The interior of the coupling sleeve 41 communicates, via through holes 45 through 48, with a fuel inlet 50 that is provided in the injector housing 4. From the fuel inlet 50, fuel subjected to high pressure reaches the interior of the injector body 4.

The interior of the injector body 4 communicates with the pressure chamber 17, via a connecting conduit or pressure conduit 54 that is recessed out of the nozzle body 2. An arrow 56 indicates that fuel subjected to high pressure passes from a central high-pressure fuel source (not shown), such as a common rail, to reach the fuel inlet 50.

The end face, toward the combustion chamber, of a piezoelectric actuator 58 rests on the end face, remote from the combustion chamber, of the bottom 40 of the coupling sleeve 41. In the state of the injector shown in the drawing, the piezoelectric actuator 58 is in the currentless state. When current is supplied to the injector 58, then it expands and presses against the end face, remote from the combustion chamber, of the bottom 40 of the coupling sleeve 41. This pressure force is transmitted via the circular-cylindrical jacket 43 of the coupling sleeve 41 to the first booster piston 24 and leads to a pressure increase in the first control chamber 21.

This pressure increase is transmitted, via the flat face 20 on the nozzle needle 8, to the second control chamber 22. As a result of the pressure increase in the second control chamber 22, the second booster piston 30 is moved away from the combustion chamber, counter to the prestressing force of the nozzle spring 38, so that as a consequence of the high pressure in the pressure chamber 17 that acts on the pressure shoulder 16, the nozzle needle 8 lifts with its tip 9 from the sealing seat 11. The lifting of the nozzle needle 8 is effected not only counter to the prestressing force of the nozzle spring 38 but also counter to the high pressure acting on the face end, remote from the combustion chamber, of the second booster piston 30. When the piezoelectric actuator 58 is relieved, the nozzle needle 8 then closes.

1-10. (canceled)

11. In a common rail injector having an injector housing having a fuel inlet that is in communication with a central high-pressure fuel source outside the injector housing and with a pressure chamber inside the injector housing, from which, as a function of the pressure in a control chamber, fuel subjected to high pressure is injected into a combustion chamber of an internal combustion engine when a nozzle needle lifts from its seat, the pressure in the control chamber being controlled directly by means of an actuator, in particular a piezoelectric actuator, the improvement comprising a further control chamber connected in series with the first control chamber.

12. The common rail injector according to claim 11, further comprising a coupling sleeve is located between the actuator and a first booster piston, the first booster piston having an end face, toward the combustion chamber, defining the first control chamber, and an end face remote from the combustion chamber defining the second control chamber, each in the axial direction.

13. The common rail injector according to claim 12, wherein the first booster piston comprises a central through hole, through which the nozzle needle extends.

14. The common rail injector according to claim 13, wherein the nozzle needle, in the region of the first booster piston, comprises at least one flat face which creates a communication between the first control chamber and the second control chamber.

15. The common rail injector according to claim 12, wherein the first control chamber is defined radially outward by a first spring-prestressed control chamber limiting sleeve, which is guided in a sealing manner on the first booster piston.

16. The common rail injector according to claim 13, wherein the first control chamber is defined radially outward by a first spring-prestressed control chamber limiting sleeve, which is guided in a sealing manner on the first booster piston.

17. The common rail injector according to claim 14, wherein the first control chamber is defined radially outward by a first spring-prestressed control chamber limiting sleeve, which is guided in a sealing manner on the first booster piston.

18. The common rail injector according to claim 12, wherein the second control chamber is located in the axial direction between the first booster piston and a second booster piston whose end face remote from the combustion chamber is subjected to high pressure.

19. The common rail injector according to claim 13, wherein the second control chamber is located in the axial direction between the first booster piston and a second booster piston whose end face remote from the combustion chamber is subjected to high pressure.

20. The common rail injector according to claim 14, wherein the second control chamber is located in the axial direction between the first booster piston and a second booster piston whose end face remote from the combustion chamber is subjected to high pressure.

21. The common rail injector according to claim 15, wherein the second control chamber is located in the axial direction between the first booster piston and a second booster piston whose end face remote from the combustion chamber is subjected to high pressure.

22. The common rail injector according to claim 18, wherein the second booster piston is located inside the coupling sleeve in such a manner that it is movable back and forth in the axial direction between the nozzle needle and a nozzle spring that is braced on the end of the coupling sleeve remote from the combustion chamber.

23. The common rail injector according to claim 19, wherein the second booster piston is located inside the coupling sleeve in such a manner that it is movable back and forth in the axial direction between the nozzle needle and a nozzle spring that is braced on the end of the coupling sleeve remote from the combustion chamber.

24. The common rail injector according to claim 20, wherein the second booster piston is located inside the coupling sleeve in such a manner that it is movable back and forth in the axial direction between the nozzle needle and a nozzle spring that is braced on the end of the coupling sleeve remote from the combustion chamber.

25. The common rail injector according to claim 21, wherein the second booster piston is located inside the coupling sleeve in such a manner that it is movable back and forth in the axial direction between the nozzle needle and a nozzle spring that is braced on the end of the coupling sleeve remote from the combustion chamber.

26. The common rail injector according to claim 18, wherein the second control chamber is defined radially outward by a second spring-prestressed control chamber limiting sleeve, which is guided in a sealing manner on the second booster piston.

27. The common rail injector according to claim 22, wherein the second control chamber is defined radially outward by a second spring-prestressed control chamber limiting sleeve, which is guided in a sealing manner on the second booster piston.

28. The common rail injector according to claim 12, wherein the coupling sleeve substantially has the shape of a circular-cylindrical jacket, which is closed on its end remote from the combustion chamber and is opened on its end toward the combustion chamber.

29. The common rail injector according to claim 13, wherein the coupling sleeve substantially has the shape of a circular-cylindrical jacket, which is closed on its end remote from the combustion chamber and is opened on its end toward the combustion chamber.

30. The common rail injector according to claim 19, further comprising at least one through hole in the jacket face of the coupling sleeve, through which at least one through hole fuel subjected to high pressure reaches the interior of the coupling sleeve.
